(19) United States
(12) Patent Application Publication
(10) Pub. No.: US 2021/0152326 A1
(43) Pub. Date: May 20, 2021

(54) WHITE-BOX ENCRYPTION METHOD FOR PREVENTION OF FAULT INJECTION ATTACK AND APPARATUS THEREFOR

(71) Applicant: ELECTRONICS AND TELECOMMUNICATIONS RESEARCH INSTITUTE, Daejeon (KR)

(72) Inventors: Seung-Kwang LEE, Daejeon (KR); You-Sung KANG, Daejeon (KR); Do-Young CHUNG, Daejeon (KR)

(73) Assignee: ELECTRONICS AND TELECOMMUNICATIONS RESEARCH INSTITUTE, Daejeon (KR)

(21) Appl. No.: 16/863,232

(22) Filed: Apr. 30, 2020

(30) Foreign Application Priority Data
Nov. 14, 2019 (KR) 10-2019-0145591

(51) Int. Cl. H04L 9/00; H04L 9/06; H03M 7/42

(52) U.S. Cl. CPC H04L 9/004; H04L 9/0631; H04L 2209/16; H04L 9/008; H03M 7/42

(57) ABSTRACT

Disclosed herein are a white-box encryption method for preventing a fault injection attack and an apparatus for the same. The white-box encryption method is configured to acquire a first intermediate value by inputting plaintext to a first part, among all of rounds of a white-box-based encryption algorithm, before table redundancy operations are performed, to input the first intermediate value to a second part for performing the table redundancy operations through at least two lookup tables to which different encodings based on a secret key are applied, among all of the rounds, to acquire a second intermediate value by inputting the output values of the at least two lookup tables to at least one XOR lookup table, and to output ciphertext for the plaintext based on a third part for decoding the second intermediate value.

### CROSS REFERENCE TO RELATED APPLICATION

This application claims the benefit of Korean Patent Application No. 10-2019-0145591, filed Nov. 14, 2019, which is hereby incorporated by reference in its entirety into this application.

### BACKGROUND OF THE INVENTION

### 1. Technical Field

The present invention relates generally to white-box encryption technology for preventing a fault injection attack, and more particularly to encryption technology capable of preventing a fault injection attack by replacing the use of a conditional branch with a comparison operation through an encoded lookup table.

### 2. Description of the Related Art

Generally, attacks on a symmetric-key cipher include all possible methods for discovering an undisclosed secret key used in an encryption algorithm. For example, attack methods may be classified into a black-box attack based on input and output, a side-channel analysis attack in which analysis can be performed without invading a computing device when encryption is executed, and a white-box attack through which all resources within a computing device can be accessed and modified.

White-box encryption is configured in such a way that, after a lookup table is formed by enumerating the results of each operation for all input values, nonlinear and linear transformations (encoding) are applied in order to protect a secret key from white-box attacks. Accordingly, most cryptographic operations are implemented using table lookups, and neither the secret key nor information about the linear and nonlinear transformations used for encoding remains. Here, in order to prevent the size of the lookup table from excessively increasing, tables are formed by dividing a cryptographic operation into smaller units, after which encoding is performed.

Also, as a kind of side-channel analysis attack, there is a fault injection attack, which aims to efficiently discover a secret key based on the relationship between correct ciphertext and faulty ciphertext, which is acquired by injecting a fault when encryption is executed. Here, fault injection may be performed using any of various methods such as rapidly changing voltage, changing a clock of a central processing unit, applying a laser beam, and the like.

The most basic method for preventing fault injection is to perform the same cryptographic operation twice for the same input, that is, for plaintext, and to compare the acquired two pieces of ciphertext with each other. This method is based on the fact that, when an intermediate value is changed through fault injection, rather than through direct access to the internal resources of a computing device, the probability that the intermediate value is changed to the same value is very low.

However, in order to avoid the above-described ciphertext comparison method, another attack method for bypassing execution of a conditional branch, such as an if statement or the like, by injecting another fault when the conditional branch is executed has emerged, but the attack method has a limitation in which there is a low probability that a fault will be injected at the exact time that the corresponding conditional branch is executed.

Also, because a fault injection attack is based on the relationship between correct ciphertext and the finally acquired faulty ciphertext, rather than an intermediate value, white-box encryption is also insufficient to prevent fault injection attacks. Further, the ciphertext comparison method using a conditional branch is not adequate because a white-box attacker is easily able to circumvent the conditional branch by accessing internal resources. Also, unlike the case of a general fault injection attack, a white-box attacker is easily able to change internal resources to desired values, which may increase the accuracy of the fault injection attack.

In addition to the above-described redundant (duplicate) operation and comparison, there may be used a fault propagation method in which, when a fault causes a change of one byte of an intermediate value, the change affects the entire intermediate value such that analysis of a secret key is impossible or the complexity thereof significantly increases. However, a complete method has not been made known, and this method is also incapable to preventing a fault injection attack based on a white-box attack.

### [Documents of Related Art]

(Patent Document 1) Korean Patent Application Publication No. 10-2018-0110550, published on Oct. 10, 2018 and titled “White-box cryptography method and apparatus for preventing side-channel analysis”.

### SUMMARY OF THE INVENTION

An object of the present invention is to provide white-box encryption technology through which a fault injection attack by a white-box attacker may be prevented.

Another object of the present invention is to provide encryption technology that may replace the use of a conditional branch with a comparison operation through an encoded lookup table.

A further object of the present invention is to provide encryption technology for preventing a fault injection attack by excluding the use of a branch that can be skipped or circumvented by a white-box attacker.

In order to accomplish the above objects, a white-box encryption method for preventing a fault injection attack according to the present invention may include acquiring a first intermediate value by inputting plaintext to a first part, among all of the rounds of a white-box-based encryption algorithm, before table redundancy operations are performed; inputting the first intermediate value to a second part for performing the table redundancy operations through at least two lookup tables to which different encodings based on a secret key are applied, among all of the rounds; acquiring a second intermediate value by inputting the output values of the at least two lookup tables to at least one XOR lookup table; and outputting ciphertext for the plaintext based on a third part for decoding the second intermediate value.

Here, acquiring the second intermediate value may include decoding the output values of the at least two lookup tables based on the at least one XOR lookup table; and performing an XOR operation on the decoded output values of the at least two lookup tables and encoding the result value of the XOR operation.

Here, the different encodings may include different undisclosed linear transformations and nonlinear transformations.

Here, in the first part, a shared lookup table generated based on the secret key may be shared in each round, and in the second part, each of the at least two lookup tables may be applied to a single round.

Here, the third part may include the last round, among all of the rounds, and perform an inverse transformation for at least two linear transformations combined through the XOR operation, and the at least two linear transformation may be linear transformations applied to the at least two lookup tables.

Here, the first part may include some rounds predicted not to be under a fault injection attack, among all of the rounds.

Here, the table redundancy operations may be redundantly performed in all of the rounds, and when the table redundancy operations are performed in a first round, the plaintext may be input to the at least two lookup tables.

Also, a white-box encryption apparatus for preventing a fault injection attack according to an embodiment of the present invention may include a processor configured to acquire a first intermediate value by inputting plaintext to a first part, among all of the rounds of a white-box-based encryption algorithm, before table redundancy operations are performed, to input the first intermediate value to a second part for performing the table redundancy operations through at least two lookup tables to which different encodings based on a secret key are applied, among all of the rounds, to acquire a second intermediate value by inputting the output values of the at least two lookup tables to at least one XOR lookup table, and to output ciphertext for the plaintext based on a third part for decoding the second intermediate value; and memory for storing the secret key.

Here, the processor may decode the output values of the at least two lookup tables based on the at least one XOR lookup table, perform an XOR operation on the decoded output values of the at least two lookup tables, and encode the result value of the XOR operation.

Here, the different encodings may include different undisclosed linear transformations and nonlinear transformations.

Here, in the first part, a shared lookup table generated based on the secret key may be shared in each round, and in the second part, each of the at least two lookup tables may be applied to a single round.

Here, the third part may include the last round, among all of the rounds, and perform an inverse transformation for at least two linear transformations combined through the XOR operation, and the at least two linear transformations may be linear transformations applied to the at least two lookup tables.

Here, the first part may include some rounds predicted not to be under a fault injection attack, among all of the rounds.

Here, the table redundancy operations may be redundantly performed in all of the rounds, and when the table redundancy operations are performed in a first round, the plaintext may be input to the at least two lookup tables.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart illustrating a white-box encryption method for preventing a fault injection attack according to an embodiment of the present invention;

FIG. 2 is a view illustrating a general table lookup sequence of a WB-AES algorithm;

FIG. 3 is a view illustrating lookup table partitions of a WB-AES algorithm according to the present invention;

FIG. 4 is a view illustrating an example of the TypeIV process illustrated in FIGS. 2 to 3;

FIG. 5 is a view illustrating an example of the TypeII and TypeIV_II lookups illustrated in FIGS. 2 to 3;

FIG. 6 is a view illustrating an example of the TypeIII and TypeIV_III lookups illustrated in FIGS. 2 to 3;

FIG. 7 is a view illustrating an example of a table redundancy operation process according to the present invention;

FIGS. 8 to 9 are views illustrating another example of a table redundancy operation process according to the present invention; and

FIG. 10 is a block diagram illustrating a white-box encryption apparatus for preventing a fault injection attack according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

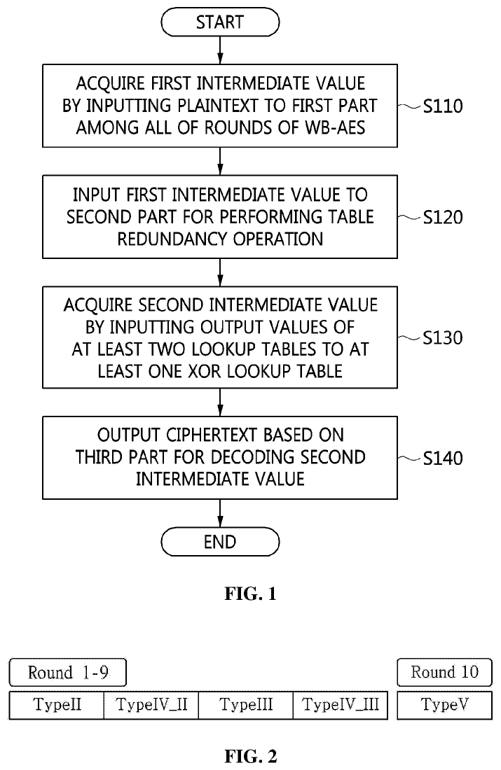

FIG. 1 is a flowchart illustrating a white-box encryption method for preventing a fault injection attack according to an embodiment of the present invention.

The present invention is for proposing an encryption scheme for preventing a fault injection attack on a white-box cipher, and relates to a method for replacing the use of a conditional branch with a comparison operation through an encoded lookup table.

The existing method for detecting fault injection through a redundant (duplicate) operation and a comparison may be easily incapacitated in a manner in which a white-box attacker having permission to access all resources bypasses a conditional branch. Therefore, the present invention intends to propose a duplication operation and comparison method in which a comparison operation using a branch is replaced with a lookup table to which linear and nonlinear transformations are applied, whereby a fault injection attack may be prevented without the use of a conditional branch that can be circumvented by a white-box attacker.

Referring to FIG. 1, in the white-box encryption method for preventing a fault injection attack according to an embodiment of the present invention, plaintext is input to a first part, among all of the rounds of a white-box-based encryption algorithm, before table redundancy operations are performed, whereby a first intermediate value is obtained at step S110.

Hereinafter, a description will be made based on a WB-AES-128 bit algorithm including a total of ten rounds for the convenience of description.

FIGS. 2 to 3 of the present invention illustrate a general table lookup sequence of a WB-AES-128 bit algorithm and the lookup table partitions of the WB-AES-128 bit algorithm that are separated into parts from a first part 310 to a third part 330 according to the present invention.

In the present invention, the general table lookup sequence illustrated in FIG. 2 may be divided into three parts, as illustrated in FIG. 3, and then different cryptographic operations may be performed in the respective parts.

Here, the first part may include some rounds predicted not to be under a fault injection attack, among all of the rounds. Accordingly, a shared lookup table generated based on a secret key may be shared in every round in the first part.

Here, the total size of the table and the number of lookups are reduced because of the shared lookup table, whereby the amount of memory or time resources required for encryption may be reduced.

Here, the table lookup sequence illustrated in FIG. 2 and FIG. 3 may be simply described as follows.

First, referring to FIG. 5, TypeII may output an intermediate value that is linearly transformed to 32 bits based on a table lookup, and an XOR operation between the intermediate values encoded by TypeII may be performed by TypeIV.

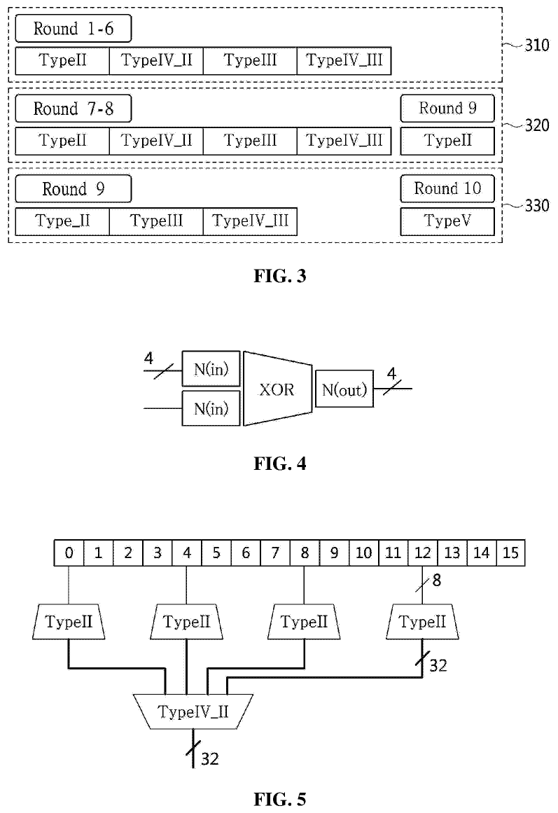

For example, TypeIV may output an encoded 4-bit XOR operation result based on two encoded 4-bit input values, as illustrated in FIG. 4. In this manner, 32-bit intermediate values encoded by TypeII are input, and an XOR operation is performed thereon, whereby a single 32-bit intermediate value may be output.

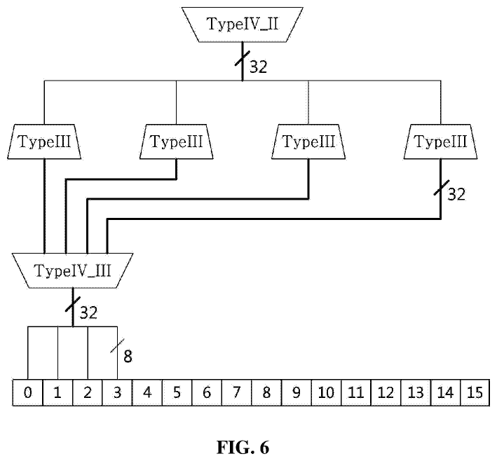

Similarly, referring to FIG. 6, TypeIII may output an intermediate value that is linearly transformed to 32 bits based on a table lookup, and a single 32-bit intermediate value may be output through an XOR operation in TypeIV_III.

Also, in the white-box encryption method for preventing a fault injection attack according to an embodiment of the present invention, the first intermediate value is input to a second part for performing the table redundancy operations through at least two lookup tables to which different encodings (encoding methods) based on a secret key are applied, among all of the rounds, at step S120.

Hereafter, the lookup table may correspond to a set of lookup tables. In this case, the lookup table may include a plurality of lookup tables. Therefore, at least two lookup tables may correspond to at least two sets of lookup tables.

Here, each of the at least two lookup tables performs a linear transformation and a nonlinear transformation, and the linear transformation may be performed in different manners for the respective at least two lookup tables.

Here, in the second part, each of the at least two lookup tables may be applied to a single round.

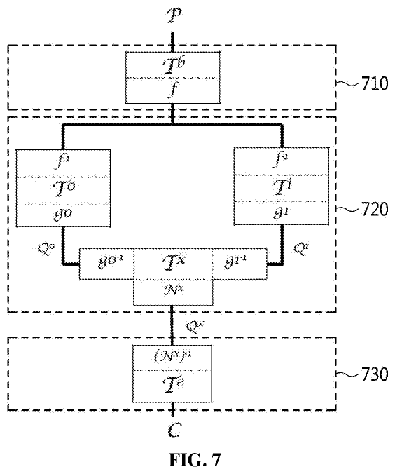

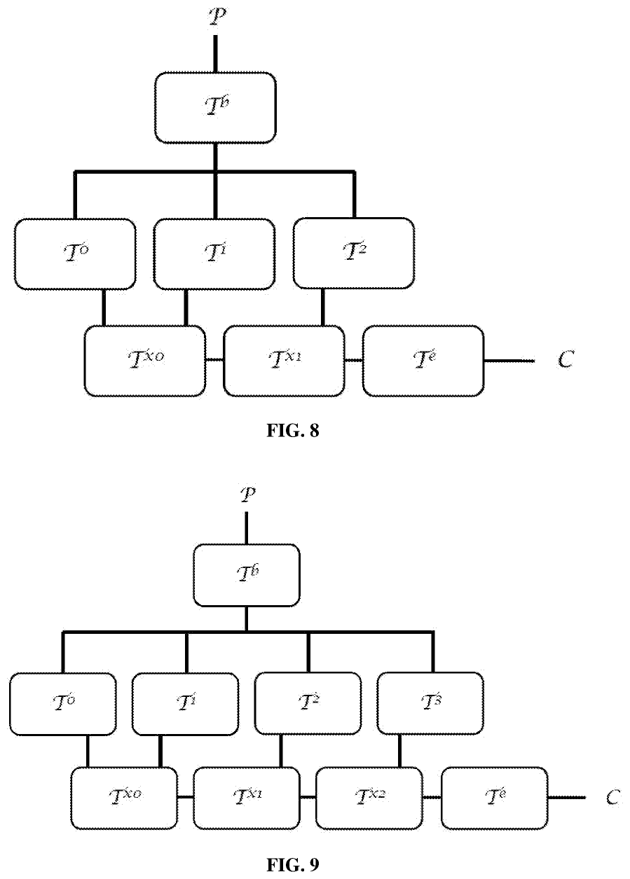

Hereinafter, the process of performing the table redundancy operations through two lookup tables to which different encodings (encoding methods) are applied will be described with reference to FIG. 7.

For example, referring to FIG. 7, when plaintext P is input to a first part 710, a first intermediate value f, which is encoded based on a shared lookup table T^{b}, may be acquired. Here, based on a WB-AES-128 bit algorithm, the first part may include first to sixth rounds, in which case the first intermediate value f may be the output value of the sixth round.

Subsequently, in seventh and eighth rounds, corresponding to a second part 720, operations based on a lookup table T⁰ and a lookup table T¹, to which different encodings g0 and g1 are applied, are performed on the same input value f¹, whereby Q⁰ and Q¹ may be output. That is, using the different lookup tables, duplicate (or redundant) operations may be performed for the same input value.

Here, each of g0 and g1 may correspond to an encoding method including a linear transformation and a nonlinear transformation.

Here, Q⁰ and Q¹, output by the seventh round and the eighth round, may be values acquired by applying linear and nonlinear transformations to ciphertext C, which is output by the sixth round, using g0 and g1.

For example, when linear and nonlinear transformations of g0 are assumed to be L0 and N0 and when linear and nonlinear transformations of g1 are assumed to be L1 and N1, Q⁰ and Q¹ may be represented as shown in Equation (1):

Q⁰=N0·L0(C)

Q¹=N1·L1(C) (1)

That is, values acquired by decoding Q⁰ and Q¹ respectively based on g0⁻¹ and g1⁻¹ may correspond to the ciphertext C output by the sixth round.

Also, in the white-box encryption method for preventing a fault injection attack according to an embodiment of the present invention, the output values of the at least two lookup tables are input to at least one XOR lookup table, whereby a second intermediate value is acquired at step S130.

Here, based on the at least one XOR lookup table, the output values of the at least two lookup tables may be decoded, an XOR operation may be performed on the decoded output values of the at least two lookup tables, and the result value of the XOR operation may be encoded.

The process of outputting the second intermediate value is described as follows with reference to FIG. 7.

For example, Q⁰, which is the output value of the seventh round, and Q¹, which is the output value of the eighth round, shown in FIG. 7 may be input to the XOR lookup table T^{x}, corresponding to the ninth round. Here, the XOR lookup table T^{x} decodes Q⁰ and Q¹ respectively based on g0⁻¹ and g1⁻¹, performs an XOR operation on the decoded Q⁰ and Q¹, and encodes the result of the XOR operation with N^{x}, thereby outputting the second intermediate value.

Because the second intermediate value is encoded using different undisclosed linear transformations and nonlinear transformations based on the above-described process, a white-box attacker is not able to predict the decoded values.

Here, the at least one XOR lookup table may receive, as input, the output values of any two lookup tables, among the at least two lookup tables.

For example, FIG. 8 shows an encryption method for performing the table redundancy operations through three lookup tables to which different encodings (encoding methods) are applied, and FIG. 9 shows an encryption method for performing the table redundancy operations through four lookup tables to which different encodings are applied.

Here, referring to FIG. 8 and FIG. 9, it is confirmed that each of T^{x0}, T^{x1} and T^{x2}, which are XOR lookup tables, receives values output from two lookup tables to which different encodings are applied. That is, when the number of redundant operations is increased by adding a lookup table to which a different encoding is applied, a second intermediate value may be generated based on an XOR lookup table corresponding to each of the redundant operations.

Accordingly, the number of one or more XOR lookup tables may be one less than the number of two or more lookup tables.

Also, in the white-box encryption method for preventing a fault injection attack according to an embodiment of the present invention, ciphertext for the plaintext may be output at step S140 based on a third part for decoding the second intermediate value.

Here, the third part includes the last round, among all of the rounds. In the last round, an inverse linear transformation, which is the inverse of the linear transformation applied to the at least two lookup tables, is performed on the value acquired by decoding the second intermediate value, whereby the ciphertext may be output.

For example, referring to FIG. 7, the third part 730 is configured such that decoding (N^{x})⁻¹ is performed on Q^{x}, which is the second intermediate value output from the second part 720, and the inverse linear transformation of L⁰ and L¹, which are the linear transformations performed in the seventh and eighth rounds, is performed based on the lookup table T^{e} of the tenth round, which is the last round, whereby the ciphertext C may be output. Here, L⁰ and L¹ may be detected in the manner shown in Equation (2):

L⁰ ⊕ L¹=(L^{e})⁻¹ (2)

Here, L^{e} may be a binary matrix corresponding to a 32×32 invertible matrix, and based on the distributive property of a linear transformation, L⁰ and L¹ may be detected in the manner shown in Equation (3):

L¹=(L^{e})⁻¹ ⊕ L⁰

L⁰=(L^{e})⁻¹ ⊕ L¹ (3)

That is, the third part of the present invention applies a linear transformation that is configured to output correct ciphertext only when the values acquired by decoding the output values of the table redundancy operations in the second part are the same as each other. Therefore, in the event of a fault injection attack, the probability that correct ciphertext is output is decreased.

Here, the table redundancy operations proposed in the present invention may be redundantly performed in all of the rounds of a white-box-based encryption algorithm.

For example, when a total of ten rounds are present, the table redundancy operations are performed from the first to tenth rounds, and ciphertext may be output by combining the results at the end.

If the table redundancy operations are performed from the first round so as to be performed on the plaintext input to the encryption algorithm, the plaintext that is not specially encoded is input to at least two lookup tables, whereby the table redundancy operations may be performed.

Here, an XOR lookup table, configured to perform an XOR operation in order to combine the output values of the table redundancy operations redundantly performed in all of the rounds, may perform applied decoding on the output values of the redundant operations, but may provide an output value without performing encoding on the final ciphertext.

Also, although not illustrated in FIG. 1, in the white-box encryption method for preventing a fault injection attack according to an embodiment of the present invention, various kinds of information generated during the above-described white-box encryption process is stored in a separate storage module.

Through the above-described white-box encryption method for preventing a fault injection attack, two intermediate values may be compared without the use of a conditional instruction such as an if statement. That is, the intermediate values acquired through table redundancy operations are compared through a lookup table for performing an XOR operation, whereby a branch, which can be skipped or circumvented by a white-box attacker, may be excluded.

Also, because a white-box attacker is not able to obtain useful information through an encoded value, a fault injection attack on a white-box cipher may be prevented.

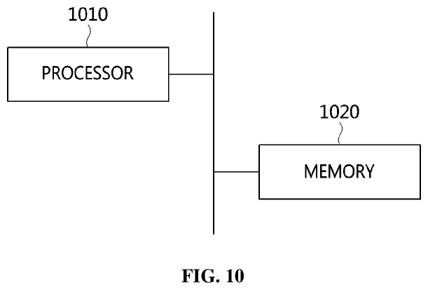

FIG. 10 is a block diagram illustrating a white-box encryption apparatus for preventing a fault injection attack according to an embodiment of the present invention.

Referring to FIG. 10, the white-box encryption apparatus for preventing a fault injection attack according to an embodiment of the present invention includes a processor 1010 and memory 1020.

The present invention proposes an encryption method for preventing a fault injection attack on a white-box cipher, and relates to an encryption apparatus for replacing the use of a conditional branch with a comparison operation through an encoded lookup table.

The existing method for detecting fault injection through redundant operations and a comparison may be easily incapacitated in a manner in which a white-box attacker having permission to access all resources bypasses a conditional branch. Therefore, the present invention intends to propose a duplicate operation and comparison method in which a comparison operation using a branch is replaced with a lookup table to which linear and nonlinear transformations are applied, whereby a fault injection attack may be prevented without the use of a conditional branch, which can be circumvented by a white-box attacker.

The processor 1010 acquires a first intermediate value by inputting plaintext to a first part, among all of the rounds of a white-box-based encryption algorithm, before the table redundancy operations are performed.

Hereinafter, a description will be made based on a WB-AES-128 bit algorithm including a total of ten rounds for the convenience of description.

FIGS. 2 to 3 of the present invention illustrate a general table lookup sequence of a WB-AES-128 bit algorithm and the lookup table partitions of the WB-AES-128 bit algorithm that are separated into parts from a first part 310 to a third part 330 according to the present invention.

In the present invention, the general table lookup sequence illustrated in FIG. 2 may be divided into three parts, as illustrated in FIG. 3, and then different cryptographic operations may be performed in the respective parts.

Here, the first part may include some rounds predicted not to be under a fault injection attack, among all of the rounds. Accordingly, a shared lookup table generated based on a secret key may be shared in every round in the first part.

Here, the total size of the table and the number of lookups are reduced because of the shared lookup table, whereby the amount of memory or time resources required for encryption may be reduced.

Here, the table lookup sequence illustrated in FIG. 2 and FIG. 3 may be simply described as follows.

First, referring to FIG. 5, TypeII may output an intermediate value that is linearly transformed to 32 bits based on a table lookup, and an XOR operation between the intermediate values encoded by TypeII may be performed by TypeIV.

For example, TypeIV may output an encoded 4-bit XOR operation result based on two encoded 4-bit input values, as illustrated in FIG. 4. In this manner, 32-bit intermediate values encoded by TypeII are input, and an XOR operation is performed thereon, whereby a single 32-bit intermediate value may be output.

Similarly, referring to FIG. 6, TypeIII may output an intermediate value that is linearly transformed to 32 bits based on a table lookup, and a single 32-bit intermediate value may be output through an XOR operation in TypeIV_III.

Also, the processor 1010 inputs the first intermediate value to a second part for performing the table redundancy operations through at least two lookup tables to which different encodings based on a secret key are applied, among all of the rounds.

Here, each of the at least two lookup tables performs a linear transformation and a nonlinear transformation, and the linear transformation may be performed in different manners for the respective at least two lookup tables.

Here, in the second part, each of the at least two lookup tables may be applied to a single round.

Hereinafter, the process of performing the table redundancy operations through two lookup tables to which different encodings are applied will be described with reference to FIG. 7.

For example, referring to FIG. 7, when plaintext P is input to a first part 710, a first intermediate value f, which is encoded based on a shared lookup table T^{b}, may be acquired. Here, based on a WB-AES-128 bit algorithm, the first part may include first to sixth rounds, in which case the first intermediate value f may be the output value of the sixth round.

Subsequently, in seventh and eighth rounds, corresponding to a second part 720, operations based on a lookup table T⁰ and a lookup table T¹, to which different encodings g0 and g1 are applied, are performed on the same input value f¹, whereby Q⁰ and Q¹ may be output. That is, using the different lookup tables, the table redundancy operations may be performed for the same input value.

Here, each of g0 and g1 may correspond to an encoding method including a linear transformation and a nonlinear transformation.

Here, Q⁰ and Q¹, output by the seventh round and the eighth round, may be values acquired by applying linear and nonlinear transformations of g0 and g1 to ciphertext C, which is output by the sixth round.

For example, when linear and nonlinear transformations of g0 are assumed to be L0 and N0 and when linear and nonlinear transformations of g1 are assumed to be L1 and N1, Q⁰ and Q¹ may be represented as shown in Equation (1):

Q⁰=N0·L0(C)

Q¹=N1·L1(C) (1)

That is, values acquired by decoding Q⁰ and Q¹ respectively based on g0⁻¹ and g1⁻¹ may correspond to the ciphertext C output by the sixth round.

Also, the processor 1010 inputs the output values of the at least two lookup tables to at least one XOR lookup table, thereby acquiring a second intermediate value.

Here, based on the at least one XOR lookup table, the output values of the at least two lookup tables may be decoded, an XOR operation may be performed on the decoded output values of the at least two lookup tables, and the result value of the XOR operation may be encoded.

The process of outputting the second intermediate value is described as follows with reference to FIG. 7.

For example, Q⁰, which is the output value of the seventh round, and Q¹, which is the output value of the eighth round, shown in FIG. 7 may be input to the XOR lookup table T^{x}, corresponding to the ninth round. Here, the XOR lookup table T^{x} decodes Q⁰ and Q¹ respectively based on g0⁻¹ and g1⁻¹, performs an XOR operation on the decoded Q⁰ and Q¹, and encodes the result of the XOR operation with N^{x}, thereby outputting the second intermediate value.

Because the second intermediate value is encoded using different undisclosed linear transformations and nonlinear transformations based on the above-described process, a white-box attacker is not able to predict the decoded values.

Here, the at least one XOR lookup table may receive, as input, the output values of any two lookup tables, among the at least two lookup tables.

For example, FIG. 8 shows an encryption method for performing the table redundancy operations through three lookup tables to which different encodings are applied, and FIG. 9 shows an encryption method for performing the table redundancy operations through four lookup tables to which different encodings are applied.

Here, referring to FIG. 8 and FIG. 9, it is confirmed that each of T^{x0}, T^{x1}, and T^{x2}, which are XOR lookup tables, receives values output from two lookup tables to which different encodings are applied. That is, when the number of redundant operations is increased by adding a lookup table to which a different encoding is applied, a second intermediate value may be generated based on the XOR lookup table corresponding to each of the redundant operations.

Accordingly, the number of one or more XOR lookup tables may be one less than the number of two or more lookup tables.

Also, the processor 1010 outputs ciphertext for the plaintext based on a third part for decoding the second intermediate value.

Here, the third part includes the last round, among all of the rounds. In the last round, an inverse linear transformation, which is the inverse of the linear transformation applied to the at least two lookup tables, is performed on the value acquired by decoding the second intermediate value, whereby the ciphertext may be output.

For example, referring to FIG. 7, the third part 730 is configured such that decoding (N^{x})⁻¹ is performed on Q^{x}, which is the second intermediate value output from the second part 720, and the inverse linear transformation of L⁰ and L¹, which are the linear transformations performed in the seventh and eighth rounds, is performed based on the lookup table T^{e} of the tenth round, which is the last round, whereby the ciphertext C may be output. Here, L⁰ and L¹ may be detected in the manner shown in Equation (2):

L⁰ ⊕ L¹=(L^{e})⁻¹ (2)

Here, L^{e} may be a binary matrix corresponding to a 32×32 invertible matrix, and based on the distributive property of a linear transformation, L⁰ and L¹ may be detected in the manner shown in Equation (3):

L¹=(L^{e})⁻¹ ⊕ L⁰

L⁰=(L^{e})⁻¹ ⊕ L¹ (3)

That is, the third part of the present invention applies a linear transformation that is configured to output correct ciphertext only when the values acquired by decoding the output values of the table redundancy operations in the second part are the same as each other. Therefore, in the event of a fault injection attack, the probability that correct ciphertext is output is decreased.

Here, the table redundancy operations proposed in the present invention may be redundantly performed in all of the rounds of a white-box-based encryption algorithm.

For example, when a total of ten rounds are present, the table redundancy operations are performed from the first to tenth rounds, and ciphertext may be output by combining the results at the end.

When the table redundancy operations are performed from the first round so as to be performed on the plaintext input to the encryption algorithm, the plaintext that is not specially encoded is input to at least two lookup tables, whereby the table redundancy operations may be performed.

Here, an XOR lookup table, which is configured to perform an XOR operation in order to combine the output values of the table redundancy operations redundantly performed in all of the rounds, may perform applied decoding on the output values of the redundant operations, but may provide an output value without performing encoding on the final ciphertext.

The memory 1020 may store a secret key.

Also, the memory 1020 may store various kinds of information generated in the above-described white-box encryption apparatus for preventing a fault injection attack according to an embodiment of the present invention.

According to an embodiment, the memory 1020 may support functions for performing white-box encryption by being separate from the white-box encryption apparatus for preventing a fault injection attack. Here, the memory 1020 may operate as separate mass storage, and may include a control function for performing operations.

Meanwhile, the white-box encryption apparatus for preventing a fault injection attack may include memory installed therein, whereby information is stored in the white-box encryption apparatus. In an embodiment, the memory is a computer-readable recording medium. In an embodiment, the memory may be a volatile memory unit, and in another embodiment, the memory may be a nonvolatile memory unit. In an embodiment, the storage device is a computer-readable recording medium. In different embodiments, the storage device may include, for example, a hard-disk device, an optical disk device, or any other kind of mass storage.

When the above-described white-box encryption apparatus for preventing a fault injection attack is used, two intermediate values may be compared without the use of a conditional instruction such as an if statement. That is, the intermediate values acquired through the table redundancy operations are compared through a lookup table for performing an XOR operation, whereby a branch that can be skipped or circumvented by a white-box attacker may be excluded.

Also, because a white-box attacker is not able to obtain useful information through an encoded value, a fault injection attack on a white-box cipher may be prevented.

According to the present invention, white-box encryption technology through which a fault injection attack by a white-box attacker can be prevented may be provided.

Also, the present invention may provide encryption technology in which the use of a conditional branch can be replaced with a comparison operation through an encoded lookup table.

Also, the present invention may provide encryption technology for preventing a fault injection attack by excluding the use of a branch that can be skipped or circumvented by a white-box attacker.

As described above, the white-box encryption method and apparatus for preventing a fault injection attack according to the present invention are not limitedly applied to the configurations and operations of the above-described embodiments, but all or some of the embodiments may be selectively combined and configured, so that the embodiments may be modified in various ways.

What is claimed is:

1. A white-box encryption method for preventing a fault injection attack, comprising:
acquiring a first intermediate value by inputting plaintext to a first part, among all of rounds of a white-box-based encryption algorithm, before table redundancy operations are performed;
inputting the first intermediate value to a second part for performing the table redundancy operations through at least two lookup tables to which different encodings based on a secret key are applied, among all of the rounds;
acquiring a second intermediate value by inputting output values of the at least two lookup tables to at least one XOR lookup table; and
outputting ciphertext for the plaintext based on a third part for decoding the second intermediate value.

2. The white-box encryption method of claim 1, wherein acquiring the second intermediate value comprises:
decoding the output values of the at least two lookup tables based on the at least one XOR lookup table; and
performing an XOR operation on the decoded output values of the at least two lookup tables and encoding a result value of the XOR operation.

3. The white-box encryption method of claim 1, wherein the different encodings include different undisclosed linear transformations and nonlinear transformations.

4. The white-box encryption method of claim 1, wherein:
in the first part, a shared lookup table generated based on the secret key is shared in each round, and
in the second part, each of the at least two lookup tables is applied to a single round.

5. The white-box encryption method of claim 2, wherein the third part includes a last round, among all of the rounds, and performs an inverse transformation for at least two linear transformations combined through the XOR operation,
wherein the at least two linear transformations are linear transformations applied to the at least two lookup tables.

6. The white-box encryption method of claim 1, wherein the first part includes some rounds predicted not to be under a fault injection attack, among all of the rounds.

7. The white-box encryption method of claim 2, wherein:
the table redundancy operations are able to be redundantly performed in all of the rounds, and
when the table redundancy operations are performed in a first round, the plaintext is input to the at least two lookup tables.

8. A white-box encryption apparatus for preventing a fault injection attack, comprising:
a processor configured to acquire a first intermediate value by inputting plaintext to a first part, among all of rounds of a white-box-based encryption algorithm, before table redundancy operations are performed, to input the first intermediate value to a second part for performing the table redundancy operations through at least two lookup tables to which different encodings based on a secret key are applied, among all of the rounds, to acquire a second intermediate value by inputting output values of the at least two lookup tables to at least one XOR lookup table, and to output ciphertext for the plaintext based on a third part for decoding the second intermediate value; and
memory for storing the secret key.

9. The white-box encryption apparatus of claim 8, wherein:
the processor decodes the output values of the at least two lookup tables based on the at least one XOR lookup table, performs an XOR operation on the decoded output values of the at least two lookup tables, and encodes a result value of the XOR operation.

10. The white-box encryption apparatus of claim 8, wherein the different encodings include different undisclosed linear transformations and nonlinear transformations.

11. The white-box encryption apparatus of claim 8, wherein:
in the first part, a shared lookup table generated based on the secret key is shared in each round, and
in the second part, each of the at least two lookup tables is applied to a single round.

12. The white-box encryption apparatus of claim 9, wherein the third part includes a last round, among all of the rounds, and performs an inverse transformation for at least two linear transformations combined through the XOR operation,
wherein the at least two linear transformations are linear transformations applied to the at least two lookup tables.

13. The white-box encryption apparatus of claim 8, wherein the first part includes some rounds predicted not to be under a fault injection attack, among all of the rounds.

14. The white-box encryption apparatus of claim 9, wherein:
the table redundancy operations are able to be redundantly performed in all of the rounds, and
when the table redundancy operations are performed in a first round, the plaintext is input to the at least two lookup tables.
